(19) United States
(12) Patent Application Publication
(10) Pub. No.: US 2020/0021440 A1
(43) Pub. Date: Jan. 16, 2020

(54) SYSTEMS AND METHODS FOR REAL-TIME HASHING OF PASSWORD INFORMATION

(71) Applicant: PayPal, Inc., San Jose, CA (US)

(72) Inventor: Vidit Maniyar, San Jose, CA (US)

(21) Appl. No.: 16/036,320

(22) Filed: Jul. 16, 2018

(51) Int. Cl. H04L 9/32; G06F 21/46; G06F 21/31; G06Q 30/06

(52) U.S. Cl. CPC H04L 9/3226; H04L 9/3236; G06Q 30/06; G06F 21/31; G06F 21/46

(57) ABSTRACT

A system for real-time hashing of password information is provided. The system may be configured to perform operations that include receiving, from a user computer of a user, a first hash value corresponding to a first string input into a password field of an application provided by a service provider. The operations may also include determining, based on accessing a database using the first hash value, data characteristics corresponding to the first hash value, the data characteristics indicating use of the first string as a password value by one or more other users. Further, the operations may include determining, based on the data characteristics, a password strength corresponding to the first hash value and causing the user computer to display an indication of the password strength.

### BACKGROUND

Users may elect to create new passwords when registering an account with a service provider and/or when changing their password with the service provider for an existing account. In certain instances, the service provider my elect to provide an indication to the user of the compatibility of the password with certain password rules or relative strength of the password. Such determinations may be made based on static rule sets. Further, in some instances, the password itself may be transmitted from a user device of the user to the service provider server of the service provider.

### BRIEF DESCRIPTION OF THE DRAWINGS

FIG. 1 is a block diagram of a networked system suitable for implementing the processes described herein for real-time hashing of password information;

FIG. 2 is an is an example diagram that illustrates the process of real-time hashing of password information, according to an embodiment;

FIG. 3 is an example flow diagram for real-time hashing of password information from the perspective of a mobile device, according to an embodiment;

FIG. 4 is an example flow diagram that depicts operations of a service provider server for real-time hashing of password information, according to another embodiment; and

FIG. 5 is a block diagram of a computer system suitable for implementing one or more components in FIG. 1-4, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Systems and methods are provided for real-time hashing of password information. According to certain embodiments, a user may be presented with, via a user device, a user interface for creating a new password for an account with a service provider. For example, the user may be registering a new account with the service provider, or the user may be changing a password for an existing account with the service provider. The user interface may include a password field in which the user may input, via the user device, a new password.

As such, the user may input via the user device a first text character into the password field. In response, the user device may generate a first hash value based on the first text character. For example, the user device may apply a hashing function to the first text character to generate the first hash value. Further, the user device may transmit the first hash value to the service provider server.

The service provider server may receive the first hash value and use the first hash value to access a database. The database may store mappings between different hash values and their corresponding usage information. The usage information corresponding to a particular hash value may indicate usage of the password represented by the particular hash value by one or more other users of the service provider. For instance, the usage information may indicate a frequency or number of times the password represented by the particular hash value has been used by the one or more other users of the service provider and/or one or more users of another service provider.

As such, based on accessing the database using the first hash value, the service provider server may identify the usage information corresponding to the first hash value. Further, based on the usage information corresponding to the first hash value, the service provider server may determine a password strength associated with the first hash value (e.g., and by extension a password strength associated with the first text character). Upon determining the password strength, the service provider server may transmit an indication of the password strength back to the user device. The user device may the dynamically display a representation of the indication of the password strength corresponding to the first text character.

Additionally, the user may input via the user device a second text character after the first text character. In response, the user device may generate a second hash value based on the string that is formed by the concatenation of the second text character to the first text character. Similarly, as described above, the user device may transmit the second hash value to the service provider server, which may in turn determine a password strength associated with the second hash value based on usage information corresponding to the second hash value.

Thus, the user device may be configured to generate respective hash values based on each text string that results from successive text character inputs (and/or character deletions) into the password field. Further, the user device may transmit each respective hash value to the service provider server, which may determine a password strength corresponding to each respective hash value. An indication of the password strength for reach respective hash value may be transmitted back to the user device, which may display the indication. In this manner, the user device may be configured to dynamically display a password strength as each character is input into the password field.

For example, suppose the user inputs the text string “cat” into the password field. According to certain implementations, upon typing the character “c”, the user device may generate a hash value corresponding to “c.” The hash value may be transmitted to service provider server, which may determine a first password strength. The service provider server may transmit an indication of the first password strength back to the user device, which may display the indication of the first password strength.

Thereafter, upon inputting the character “a”, the user device may generate a hash value corresponding to the text string “ca” The hash value may be transmitted to service provider server, which may determine a second password strength for the text string “ca”. The service provider server may transmit an indication of the second password strength back to the user device, which may display the indication of the second password strength.

Then, upon inputting the character “t”, the user device may generate a hash value corresponding to the text string “cat.” The hash value may be transmitted to service provider server, which may determine a third password strength for the text string “cat”. The service provider server may transmit an indication of the third password strength back to the user device, which may display the indication of the third password strength. Thus, the password strength is continuously and dynamically updated as the user inputs text characters into the password field.

Subsequently, the user may decide to delete the character “t” from the string “cat”, thereby once again forming the string “ca” The user device again generates the hash value corresponding to the text string “ca.” and transmits the corresponding hash value to the service provider server. The service provider determines the associated password strength and transmits the determined password strength back to the user device, which displays the indication of the determined password strength.

Embodiments described herein enable the continuous and dynamic of updates of password strengths corresponding to text character inputs by the user without transmitting plain text between the user device and the service provider server. Instead, hash values of different text strings are transmitted between the user device and the service provider server, thereby preventing the plaint text of the text strings from being intercepted by a malicious third-party. Further, the database accessed by the service provider server also does not store mappings between plain text and corresponding usage information bur rather stores mappings between hash values corresponding to different plain text strings and usage information. As a result, in the event that the security of the database is compromised, the plaint text corresponding to the hash values remains unavailable to any malicious third-party actors.

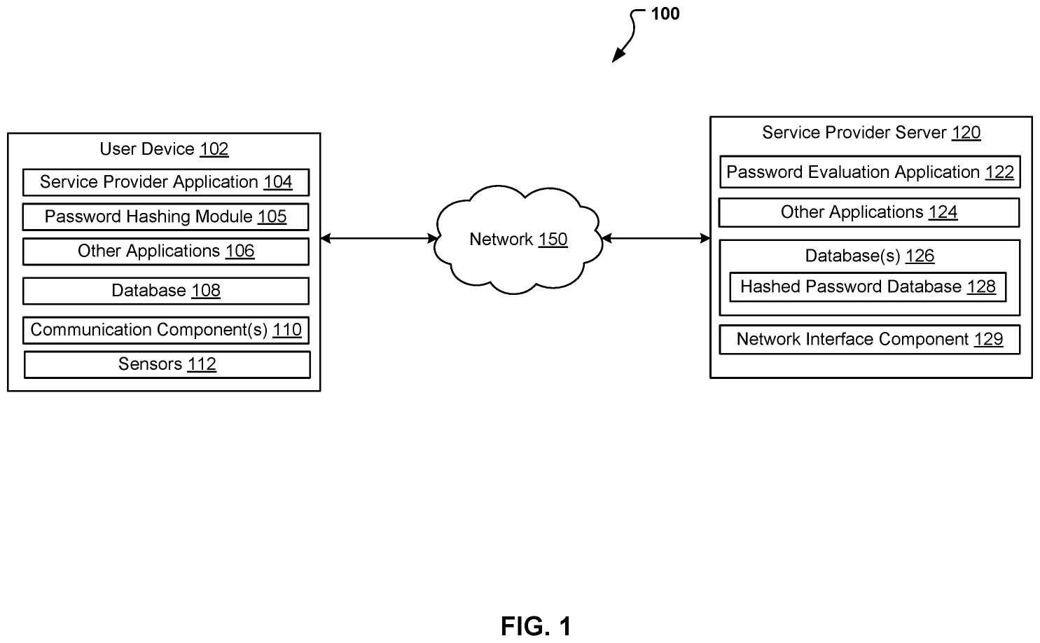

FIG. 1 is a block diagram of a networked system 100 for implementing the processes described herein, according to an embodiment. As shown, system 100 may include or implement a plurality of devices, computers, servers, and/or software components that operate to perform various methodologies in accordance with the described embodiments. Example devices, computers, and servers may include mobile devices, wearable devices, stand-alone devices, desktop computers, laptop computers, and enterprise-class servers, executing an operating system (OS) such as a MICROSOFT® OS, a UNIX® OS, a LINUX® OS, or another suitable device and/or server based OS. It will be appreciated that the devices, computers, and/or servers illustrated in FIG. 1 may be deployed differently and that the operations performed and/or the services provided by such devices, computers, and/or servers may be combined or separated for a given embodiment and may be performed by a greater number or fewer number of devices, computers, and/or servers. Furthermore, one or more of the devices, computers, and/or servers may be operated and/or maintained by the same or different entities.

System 100 includes a user device 102 configured to communicate with a service provider server 120 over a network 150. The user device 102 and the service provider server 120 may each include one or more processors, memories, and other appropriate components for executing computer-executable instructions such as program code and/or data. The computer-executable instructions may be stored on one or more computer readable mediums or computer readable devices to implement the various applications, data, and steps described herein. For example, such instructions may be stored in one or more computer readable media such as memories or data storage devices internal and/or external to various components of system 100, and/or accessible over network 150.

The user device 102 may be implemented as a communication device that may utilize appropriate hardware and software configured for wired and/or wireless communication with the service provider server 120. In certain implementations, the user device 102 may be a mobile phone, tablet, electronic wearable, laptop computer, and/or any other type of mobile computing device usable by a consumer. The user device 102 may be configured to accept various forms of payment including, but not limited to credit card payments, debit card payments, loyalty card payments, gift card payments, store card payments, and/or payment made by accessing a digital wallet.

The user device 102 may include a service provider application 104, a password hashing module 105, other applications 106, a database 108, communication components 110, and sensors 112. The service provider application 104, password hashing module 105, and other applications 106 may correspond to executable processes, procedures, and/or applications with associated hardware. In other embodiments, user device 102 may include additional or different components having specialized hardware and/or software to perform operations associated with the key management application 104, password hashing module 105, and/or the other applications 106.

The service provider application 104 may be provided and maintained by a service provider associated with the service provider server 120. In certain embodiments, the service provider may be a payment provider that provides and facilitates payments, and as such, the service provider application 104 may enable the user to make and facilitate payments.

The service provider application 104 may also enable the user of the user device 102 to register and/or access an account with the service provider. Further, the service provider application 104 may enable the user to create a new password associated with the account with the service provider. For instance, the new password may be created as part of the user registering a new account, or the new password may be created as part of the user changing an existing password of an existing account with the service provider. In any case, the service provider application 104 may be configured to present a user interface the includes a password input field for the user to input a new password to be created. Further, it will be appreciated that while certain processes may be described with reference to the service provider application 104 (e.g., including the description above regarding creating a new password), such processes may also be implemented via a web browser as well. For example, the user may use the web browser to navigate to a website maintained by the service provider. In this case, the user interface that includes the password input field may be provide via the website.

The service provider application 104 may further be configured to, for each text character input into the password input field via user the device 102, transmit a corresponding text string to the password hashing module 105. For example, the password input field may initially be blank. Subsequently, the user may input, via the user device 102, a first text character into the password input field, and the service provider application 104 may provide a first text string that includes the first text character to the password hashing module 105. Then, the user may input, via the user device 102, a second text character after the first text character into the password input field. As such, the service provider application 104 may provide a second text string to the password hashing module 105. The second text string may include the second text character concatenated with the first text character.

The password hashing module 105 may receive each of the text strings from the service provider application 104 and generate a corresponding hash value for each text string. For instance, the password hashing module 105 may generate a first hash value based on the first text string and a second hash value based on the second text string. Further, the password hashing module 105 may be configured to successively transmit each of the generated hash values to the service provider server 120. For example, after generating the first hash value, the password hashing module 105 may transmit the first hash value to the service provider 120. As will be described in more detail below, the service provider server 120 may be configured transmit a password strength indication corresponding to the first hash value back to the user device 102. As such, the user device 102 (e.g., the service provider application 104) may be configured to display the password strength indication via the user interface, such as in the vicinity of the password input field. According to certain implementations, the password strength indication may be displayed via the user interface before displaying in indication that the second text character has been input into the password input field.

Additionally, the service provider server 120 may also transmit a second password strength indication corresponding to the second hash value back to the user device 102. To this end, the user device 102 may display the second password strength indication via the user interface. In certain embodiments, the second password strength indication may be displayed after displaying the password strength indication corresponding to the first hash value.

According to certain embodiments, the service provider application 104 may configured to display password strength indications corresponding to text strings formed by each subsequent input of a text character into the password input field. Thus, the service provider application 104 may be configured to display respective password strength indications corresponding to strings formed by text character inputs into the password input field. Further, the password strength indications may be displayed without having to transmit the plaint text of the text character inputs to the service provider server, where they may be susceptible to being intercepted by malicious third-party actors.

In other implementations, the service provider application 104 may only provide a text string to the password hashing module 105 in response to determining that certain hashing criteria has been satisfied. For instance, determining that the hashing criteria is satisfied may include determining that a number of text characters that have been input into the password input field before providing the text string formed from the text character inputs to the password hashing module 105. The hashing criteria may also include input timing information. For example, determining that the hashing criteria is satisfied may include determining that a text character has not been input into the password input field for a predetermined amount of time.

It will be appreciated that in some embodiments, the password hashing module 105 may be included as part of the service provider application 104. In other embodiments, other applications maintained by other service providers may provide text strings to the hashing module 105 to generate hash values. Thus, the service provider of the service provider application 104 (e.g., and the service provider server 120) may provide password hashing services to other service providers via the password hashing module 105. For example, the user device 102 may store a different service provider application of a different service provider. The different service provider application may be configured to provide successive text strings, to the password hashing module 105, that correspond to password inputs by users of the different service provider application.

The user device 102 may execute the other applications 106 to perform various other tasks and/or operations corresponding to the user device 102. For example, the other applications 106 may include security applications for implementing client-side security features, programmatic client applications for interfacing with appropriate application programming interfaces (APIs) over network 150, or other types of applications. The other applications 106 may also include additional communication applications, such as email, texting, voice, and instant messaging (IM) applications that enable a user to send and receive emails, calls, texts, and other notifications through the network 150. In various embodiments, the other applications 106 may include location detection applications, such as a mapping, compass, and/or global positioning system (GPS) applications, which may be used to determine a location of the user device 102. The other applications 106 may include social networking applications. Additionally, the other applications 106 may include device interfaces and other display modules that may receive input and/or output information. For example, the other applications 106 may include a graphical (GUI) configured to provide an interface to the user.

In some embodiments, the other applications 106 may include a social media application that enables the user to interface with a social media platform provided by a third-party service provider. Further, the service provider may be integrated with the social media platform (and/or otherwise be in communication with the social media platform). For example, the service provider server 120 may be in communication with one or more servers or devices of the social media platform.

The user device 102 may further include a database 108, which may be stored in a memory, secure element, and/or other storage device of the user device 102. The database 108 may include, for example, identifiers (IDs) such as operating system registry entries, cookies associated with the digital wallet application 104 and/or other applications 106, IDs associated with hardware of the communication component 110, IDs used for payment/user/device authentication or identification, and/or other appropriate IDs. The database 108 may also include information corresponding to one or purchase transactions of the user who has purchased goods or services from one or more merchants, browsing histories of the user, or other types of user information. Further, the database 108 may store login credentials (e.g., such as to login to an account with the service provider and/or other accounts with other service providers), identification information, biometric information, and/or authentication information of the user. As previously discussed, the user device 102 may store an association between a unique digital key and a payment identifier associated with a payment instrument. As such, the association may be stored in the database 108, such as in the secure element.

The user device 102 may also include at least one communication component 110 configured to communicate with various other devices such as the other user devices 114 and/or the service provider server 120. In various embodiments, communication component 110 may include a Digital Subscriber Line (DSL) modem, a Public Switched Telephone Network (PTSN) modem, an Ethernet device, a broadband device, a satellite device and/or various other types of wired and/or wireless network communication devices including microwave, radio frequency, infrared, Bluetooth, Bluetooth low-energy, near field communication (NFC) devices, and/or the like.

The user device 102 may also include one or more hardware sensors 112 to determine user inputs from the user, motion of the user device 102, biometric information associated with the user, and/or various environmental data associated with the user device 102. The sensors 112 may include, but are not limited to, gyroscopes, cameras, microphones, accelerometers, barometers, thermometers, compasses, magnetometers, light detectors, proximity sensors, fingerprint sensors, pedometers, and heart rate monitors.

The service provider server 120 may be may be maintained, for example, by the service provider, which may provide payment processing services for the merchant and/or users of the payment application 106. In one example, the service provider server 114 may be provided by PAYPAL, Inc. of San Jose, Calif. USA. However, in other embodiments, the service provider server 114 may be maintained by or include a financial service provider, social networking service, email or messaging service, media sharing service, and/or other service provider, which may provide payment processing services.

The service provider server 120 includes a password evaluation application 122. The password evaluation application 122 may be configured to receive hash values from the user device 102 (e.g., the password hashing module 105). The password evaluation application 122 may use the received hash values to access a hashed password database 128. To this end, the hashed password database 128 may store mappings between hash values and corresponding data characteristics. A set of data characteristics corresponding to a particular hash value may indicate usage of the password that is represented by the hash value. For instance, the data characteristics may indicate a number of times the hash value (i.e., the password represented by the hash value) has been used as a password by one or more other users that maintain accounts with the service provider and/or accounts with other service providers.

Further, as the password evaluation application 122 receives hash values, the password evaluation application 122 may also be configured to update the hashed password database 128. That is, for each hash value, the password evaluation application 122 may update the data characteristics that are mapped to the hash value stored in the hashed password database 128.

Referring back to the example described with reference to password hashing module 105 of the user device, the password evaluation application 122 may receive the first hash value from the password hashing module 105. As a result, the password evaluation application 122 may use the first hash value to access a hashed password database 128 to determine data characteristics associated with the first hash value. Based on the data characteristics, the password evaluation application 122 may determine a password strength corresponding to the first hash value (e.g., and hence the password represented by the first hash value). The password strength may be any type of value that indicates how likely it is to be guessed by another party and/or how the common the password is deemed. In certain embodiments, the password strength may include text strings, such as “risky,” “strong,” “medium,” “excellent,” and/or the like. In other embodiments, the password strength may be a numerical value. In yet other embodiments, the password strength may be indicated by different colors and/or any combinations of the indications previously mentioned.

Upon determining the password strength, the password evaluation application 122 may transmit the password strength and/or an indication of the password strength back to the user device 102. As previously described, the user device 102 may be configured to display an indication of the password strength. Thus, in view of the interactions described above between the user device 102 and the service provider server 120, the user device's 102 transmission of hash values causes the service provider server 120 to determine relative password strengths corresponding to the transmitted hash values and to transmit respective indications of the relative password strengths back to the user device 102.

In certain embodiments, for each hash value received by the password evaluation application 122, the password evaluation application 122 may also analyze the hash value to determine whether its corresponding password complies with one or more password rules. For example, password rules may be any rules that the service provider may impose on passwords for accounts maintained by the service provider (e.g., passwords must be a certain number of characters, must contain a certain amount of upper case letters, symbols, etc.). In certain implementations, the password evaluation application 122 is configured to analyze certain properties of the hash value itself to determine whether the rules are complied with. For example, the hash value may include certain flags (e.g., if the hash value ends in “000”) that indicate a violation of one or more of the password rules. In other implementations, the password evaluation application 122 may be configured to convert the hash value back to its corresponding password and compare the corresponding password against the one or more password rules. In such cases, the password evaluation application 122 may, subsequent to the comparison, delete the corresponding password from the service provider server 120 to prevent any theft of the corresponding password.

The service provider server 120 may execute the other applications 126 to perform various other tasks and/or operations corresponding to the service provider server 120. For example, the other applications 126 may include security applications for implementing server-side security features, programmatic client applications for interfacing with appropriate application programming interfaces (APIs) over network 150, or other types of applications. The other applications 126 may also include additional communication applications, such as email, texting, voice, and instant messaging (IM) applications that enable a user to send and receive emails, calls, texts, and other notifications through the network 150. In various embodiments, the other applications 126 may include location detection applications, such as a mapping, compass, and/or global positioning system (GPS) applications. The other applications may 126 include social networking applications. Additionally, the other applications 126 may include device interfaces and other display modules that may receive input and/or output information. For example, the other applications 126 may include a GUI configured to provide an interface to a user.

The service provider server 120 may further include one or more databases 138, which may be stored in a memory and/or other storage device of the service provider server 120. The database(s) 138 may include, for example, IDs such as operating system registry entries, cookies associated with the transaction processing application 122, biometric information, IDs associated with hardware of the network interface component 129, IDs used for payment/user/device authentication or identification, and/or other appropriate IDs.

In various embodiments, the service provider server 120 also includes at least one network interface component 129 that is configured to communicate with the user device 102 and/or the other user devices 114 via the network 150. The network interface component 129 may comprise a DSL modem, an Ethernet device, a broadband device, a satellite device and/or various other types of wired and/or wireless network communication devices including microwave, RF, and IR communication devices.

The network 150 may be implemented as a single network or a combination of multiple networks. For example, in various embodiments, the network 150 may include the Internet or one or more intranets, landline networks, wireless networks, and/or other appropriate types of networks. Thus, the network 150 may correspond to small scale communication networks, such as a private or local area network, or a larger scale network, such as a wide area network or the Internet, accessible by the various components of system 100.

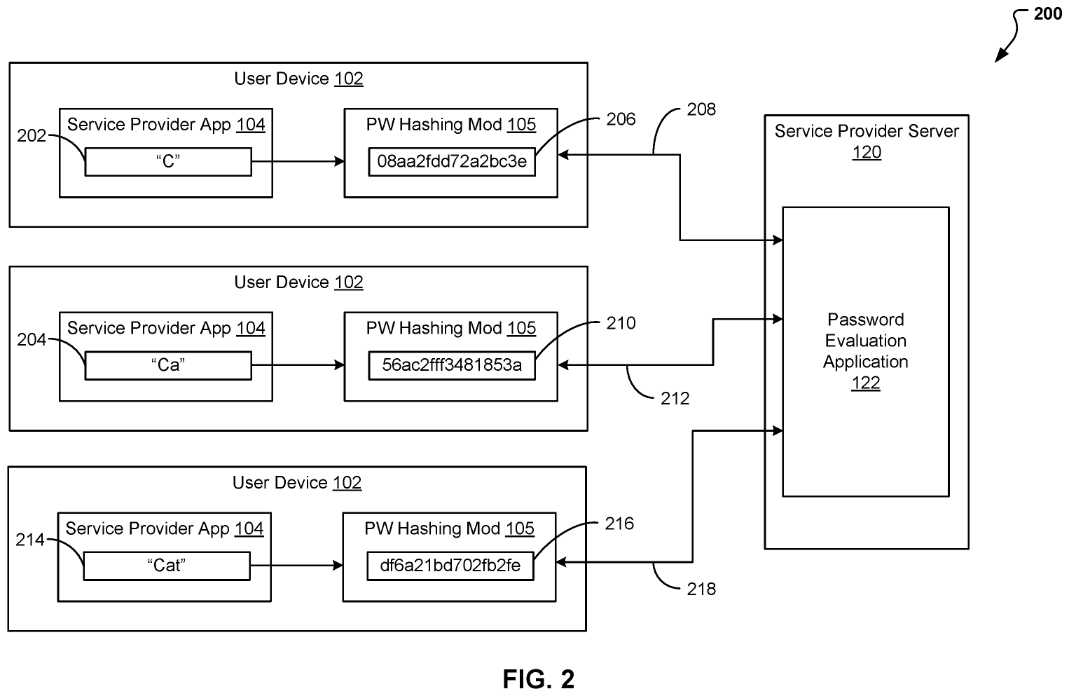

FIG. 2 illustrates a block diagram that depicts communication between the user device 102 and the service provider server 120 as a user inputs text characters into a password input field. According to certain embodiments, the user may enter a first text character into a password input field provided by a service provider application 104. The first text character may correspond to a text string “C” 202. The service provider application 104 may provide the text string “C” 202 to the password hashing module 105, which may be configured to generate a first hash value 206 based on the text string “C” 202. The password hashing module 105 may transmit 208 the first hash value 206 to the password evaluation application 122 of the service provider server 120. The password evaluation application may determine a password strength corresponding to the first hash value 206 and transmit 208 an indication of the password strength back to the user device 102.

Subsequently, the user may input a second text character “a” into the password input field. The input of the second text character “a” may be concatenated with the first text character “C” to form the text string “Ca” 204. As such, the service provider application 104 may provide the text string “Ca” 204 to the password hashing module 105, which may generate a second hash value 210 based on the text string “Ca” 204. The password hashing module 105 may transmit 212 the second hash value 210 to the password evaluation application 122, which may return 212 an indication of a password strength corresponding to the text string “Ca” 204.

Subsequently, the user may input a third text character “t” into the password input field. The input of third text character may be concatenated with the text string “Ca” to form the text string “Cat” 214. As such, the service provider application 104 may provide the text string “Cat” 214 to the password hashing module 105, which may generate a third hash value 216 based on the text string “Cat” 214. The password hashing module 105 may transmit 218 the third hash value 216 to the password evaluation application 122, which may return 218 an indication of a password strength corresponding to the text string “Cat” 214.

Thus, as the user inputs each text character into the password input field, a corresponding hash value may be generated based on the string formed by inputting the text character. The service provider server 120 may be configured to determine respective password strengths corresponding to each hash value and transmit indications of the respective password strengths back to the user device 102, which may be configured to display those indications.

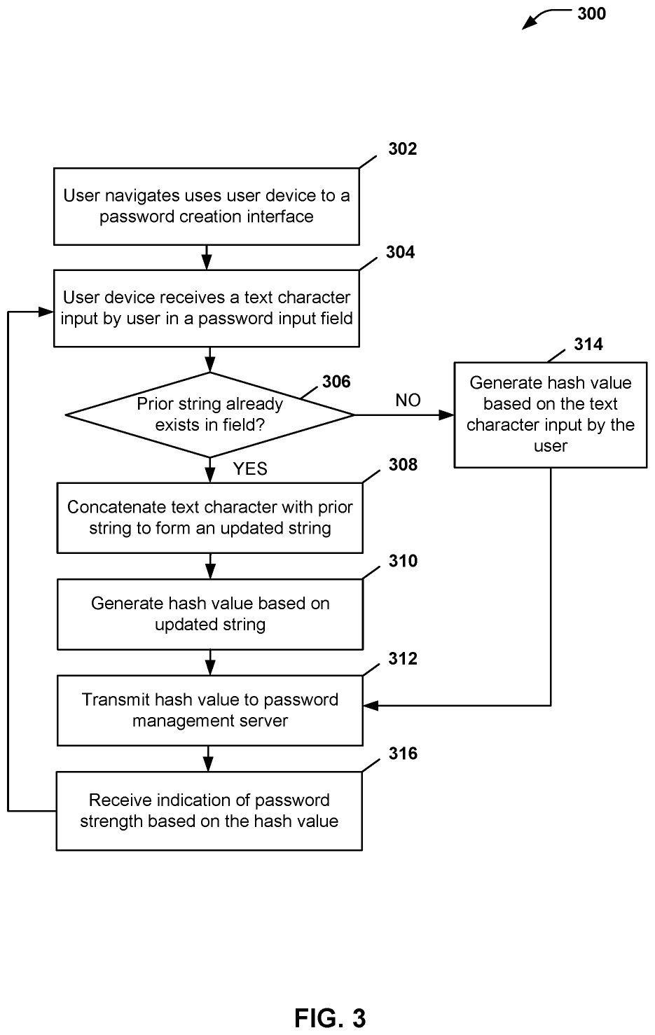

FIG. 3 illustrates a flow diagram of a method 300 for real-time hashing of password information. Note that one or more steps, processes, and methods described herein may be omitted, performed in a different sequence, or combined as desired or appropriate.

The method 300 may begin at step 302, where a user may navigate, via a user device such as user device 102, to an interface that enables the user to create a password corresponding to an account the user maintains and/or wishes to register with a service provider. As previously mentioned, the interface may be provided via a service provider application of the service provider (e.g., service provider application 104) or a website maintained by the service provider. Further, the interface may include a password input field in which the user can input potential passwords.

At step 304, the user device 102 receives a text character input by the user into the password input field. At step 306, the user device 102 may determine whether a prior string already exists in the password input field. If not, the method proceeds to step 314, where the user device 102 generates a hash value based on the text character input by the user into the password input field. From there, the method proceeds to step 312, where the user device 102 transmits the has value to a password management service (e.g., service provider server 120), and at step 316, the user devices 102 receives an indication of a password strength based on the transmitted hash value.

If, at step 306, the user device 102 determines that a prior string does exist in the password input field, the method 300 may proceed to step 308. At step 308, the user device 102 may concatenate the text character with the prior string (e.g., to the end of the prior string) to form an updated string. At step 310, the user device 102 may generate a hash value based on the updated string. Subsequently, the method 300 may proceed to step 312 and step 316, which have been previously described. Subsequent to step 316, the user device may again receive another text character input, in which case the method 300 may begin again at step 304.

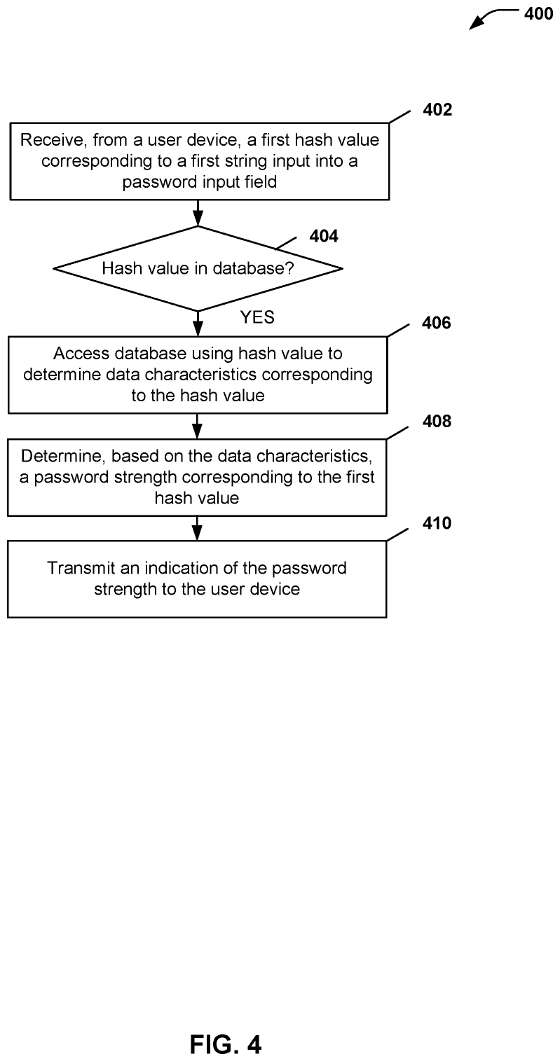

FIG. 4 illustrates a flow diagram of a method 400 of operations performed by a service provider server for real-time hashing of password information. Note that one or more steps, processes, and methods described herein may be omitted, performed in a different sequence, or combined as desired or appropriate.

The method 400 may begin in step 402, where the service provider server 120 may receive, from the user device, a first hash value corresponding to a first string input into a password field. For example, the password input field may correspond to the password input field described with reference to FIG. 3. At step 404, the service provider server 120 may determine whether the hash value is stored in a database, such as the hashed password database 128.

If the hash value is stored in the database, the service provider server 120 may access the database using the first hash value to determine data characteristics corresponding to the first hash value. For instance, as previously discussed, the database (e.g., the hashed password database 128) may store mappings between hash values and data characteristics that indicate usage of passwords corresponding to the hash values by other users of the service provider and/or other service providers.

At step 408, the service provider server 120 may determine, based on the data characteristics, a password strength corresponding to the first hash value. At step 410, the service provider server 120 may transmit an indication of the password strength to the user device 102.

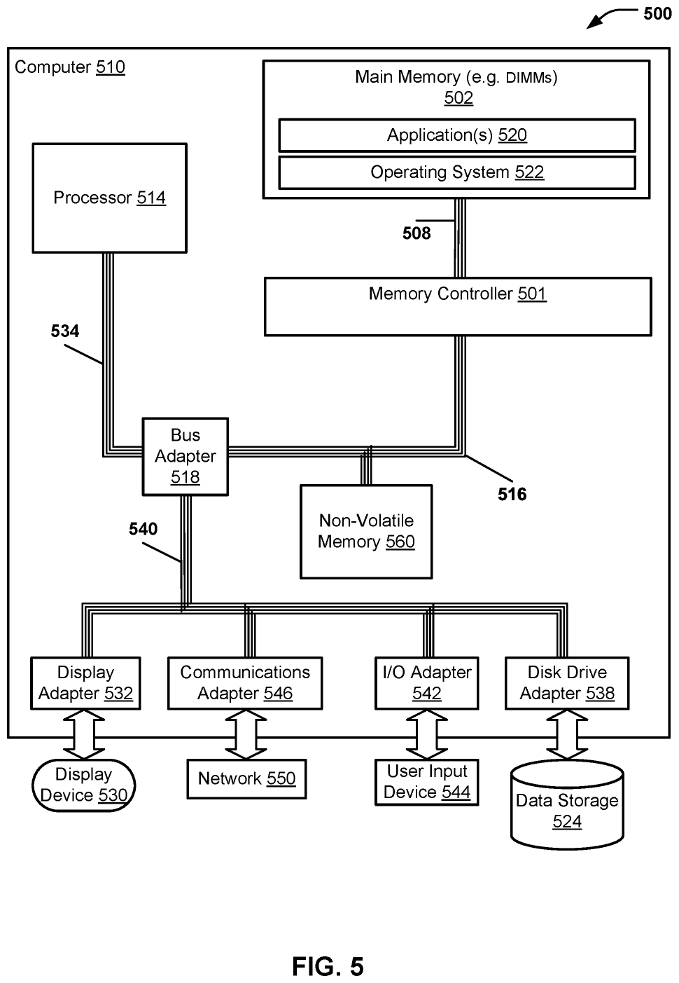

FIG. 5 is a block diagram of a computer system 500 suitable for implementing one or more components in FIG. 1 and/or FIG. 2, according to an embodiment. Referring to FIG. 5, an illustrative system 500 including a computer 510 is shown. The computer 510 may be an implementation of a computing system that includes or corresponds to the user device 102, the service provider server 114, the service provider server 120 of FIG. 1, and/or any of the entities (except the user 202) depicted in FIG. 2. The computer 510 includes at least one computer processor (CPU) 514 (e.g., a hardware processor) as well as main memory 502, a memory controller 501, and a non-volatile memory 560. The main memory 502 is connected through a memory bus 508 to the memory controller 501. The memory controller 501 and the non-volatile memory 560 are connected through a second memory bus 516 and a bus adapter 518 to the processor 514 through a processor bus 534.

Stored at the memory 502 are one or more applications 520 that may be module(s) or computer program instructions for carrying out particular tasks (e.g., the service provider application 104, password hashing module application 105, password evaluation application 122, and/or payment authorization application 124 of FIG. 1). Also stored at the main memory 502 is an operating system 522. Operating systems include, but are not limited to, UNIX® (a registered trademark of The Open Group), Linux® (a registered trademark of Linus Torvalds), Windows® (a registered trademark of Microsoft Corporation, Redmond, Wash., United States), and others as will occur to those of skill in the art. The operating system 522 and the application 520 in the example of FIG. 5 are shown in the main memory 502, but components of the aforementioned software may also, or in addition, be stored at non-volatile memory (e.g., on data storage, such as data storage 524 and/or the non-volatile memory 560).

The computer 510 includes a disk drive adapter 538 coupled through an expansion bus 540 and the bus adapter 518 to the processor 514 and other components of the computer 510. The disk drive adapter 538 connects non-volatile data storage to the computer 510 in the form of the data storage 524 and may be implemented, for example, using Integrated Drive Electronics (“IDE”) adapters, Small Computer System Interface (“SCSI”) adapters, Serial Attached SCSI (“SAS”) adapters, and others as will occur to those of skill in the art. Non-volatile computer memory also may be implemented as an optical disk drive, electrically erasable programmable read-only memory (so-called “EEPROM” or “Flash” memory), RAM drives, and other devices, as will occur to those of skill in the art. In a particular embodiment, the data storage 524 may store the data and information described herein.

The computer 510 also includes one or more input/output (“I/O”) adapters 542 that implement user-oriented input/output through, for example, software drivers and computer hardware for controlling input and output to and from user input devices 544, such as keyboards and mice. In addition, the computer 510 includes a communications adapter 546 for data communications with a data communications network 560. The data communications may be carried out serially through Recommended Standard 232 (RS-232) connections (sometimes referred to as “serial” connections), through external buses such as a Universal Serial Bus (“USB”), through data communications networks such as internet protocol (IP) data communications networks, and in other ways as will occur to those of skill in the art. The communications adapter 546 implements the hardware level of data communications through which one computer sends data communications to another computer, directly or through a data communications network. Examples of the communications adapter 546 suitable to use in the computer 510 include, but are not limited to, modems for wired dial-up communications, Ethernet (Institute of Electrical and Electronics Engineers (IEEE) 802.3) adapters for wired network communications, and IEEE 802.11 adapters for wireless network communications. The computer 510 also includes a display adapter 532 that facilitates data communication between the bus adapter 518 and a display device 530, enabling the application 520 to visually present output on the display device 530.

In various embodiments of the present disclosure, execution of instruction sequences to practice the present disclosure may be performed by computer system 500. In various other embodiments of the present disclosure, a plurality of computer systems 500 coupled by communications adapter 546 to the network (e.g., such as a LAN, WLAN, and/or various other wired or wireless networks, including telecommunications, mobile, and cellular phone networks) may perform instruction sequences to practice the present disclosure in coordination with one another.

Particular embodiments described herein may take the form of an entirely hardware embodiment, an entirely software embodiment, or an embodiment containing both hardware and software elements. In a particular embodiment, the disclosed methods are implemented in software that is embedded in processor readable storage medium or storage device and executed by a processor that includes but is not limited to firmware, resident software, microcode, etc.

Further, embodiments of the present disclosure, may take the form of a computer program product accessible from a computer-usable or computer-readable storage device providing program code (e.g., computer-executable instructions) for use by or in connection with a computer, processor, or any instruction execution system. For the purposes of this description, a computer-usable or computer-readable storage device may be non-transitory and can be any apparatus that can tangibly embody a computer program and that can contain, store, communicate, propagate, or transport the program for use by or in connection with the instruction execution system, processor, apparatus, or device.

In various embodiments, the medium can include an electronic, magnetic, optical, electromagnetic, infrared, or semiconductor system (or apparatus or device) or a propagation medium. Examples of a computer-readable storage device include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD).

A data processing system suitable for storing and/or executing program code may include at least one processor coupled directly or indirectly to memory elements through a system bus. The memory elements can include local memory employed during actual execution of the program code, bulk storage, and cache memories that may provide temporary or more permanent storage of at least some program code in order to reduce the number of times code must be retrieved from bulk storage during execution.

Input/output or I/O devices (including but not limited to keyboards, displays, pointing devices, etc.) can be coupled to the data processing system either directly or through intervening I/O controllers. Network adapters may also be coupled to the data processing system to enable the data processing system to become coupled to other data processing systems or remote printers or storage devices through intervening private or public networks. Modems, cable modems, and Ethernet cards are just a few of the currently available types of network adapters.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and features as defined by the following claims.

What is claimed is:

1. A system, comprising:
one or more hardware processors;
a secure element; and
a memory storing computer-executable instructions, that in response to execution by the one or more hardware processors, causes the system to perform operations comprising:
receiving, from a user computer of a user, a first hash value corresponding to a first string that is input into a password field of an application provided by a service provider;
determining, based on accessing a database using the first hash value, data characteristics corresponding to the first hash value, the data characteristics indicating use of the first string as a password value by one or more other users;
determining, based on the data characteristics, a password strength corresponding to the first hash value; and
causing the user computer to display an indication of the password strength.

2. The system of claim 1, wherein the operations further comprise:
receiving, from the user computer, a second hash value corresponding to a second string input into the password field, wherein the second string comprises a subsequent string concantentated to an end of the first string;
causing the user computer to display an updated indication of the password strength based on the second hash value.

3. The system of claim 2, wherein the first string and the second string each corresponds to a single character respectively.

4. The system of claim 1, wherein the database stores mappings between a plurality of hash values and respective data characteristics that indicate use of strings represented by the hash values as passwords by a plurality of users.

5. The system of claim 4, wherein the plurality of hash values include the first hash value and the plurality of users includes the one or more other users.

6. The system of claim 1, wherein the data characteristics include frequency information indicating a number of instances in which the first string represented by the first hash value has been input as a potential password for one or more applications.

7. The system of claim 1, wherein the operations further comprise:
determining whether the first hash value fails to satisfy one or more password rules based on one or more properties of the first hash value.

8. The system of claim 7, wherein the operations further comprise:
transmitting an error notification to the user computer in response to determining that the first has value fails to satisfy the one or more password rules.

9. The system of claim 1, wherein the operations further comprise:
receiving a subsequent hash value and an indication that the hash value corresponds to an attempt by the user to create a new password; and
updating data characteristics corresponding to the subsequent hash value.

10. The system of claim 1, wherein the system is maintained by the service provider and the password field corresponds user interface component provide via a service provider application of the service provider.

11. A method, comprising:
receiving, by a user computer, successive text character inputs into a password field of an application provided by a service provider, each successive text character input forming a respective text string;
for each respective text string:
generating a corresponding hash value and transmitting the corresponding hash value to a service provider server associated with the service provider;
receiving, from the service provider server in response to the transmitting of the corresponding hash value, a password strength associated with the corresponding hash value; and
displaying, by the user computer, an indication of the password strength.

12. The method of claim 11, wherein the transmitting the corresponding hash value causes the service provider server to perform operations comprising:
determining data characteristics associated with the corresponding hash value, the data characteristics indicating usage of the respective text string as a password by one or more other users.

13. The method of claim 12, wherein the data characteristics include frequency information indicating a number of instances in which the text string represented by the corresponding hash value has been input as a potential password for one or more applications.

14. The method of claim 11, wherein the transmitting the corresponding hash value to a service provider server occurs without transmitting the respective text string to the service provider server.

15. A non-transitory computer readable medium storing computer-executable instructions that in response to execution by one or more hardware processors, causes a payment provider system to perform operations comprising:
receiving, from a user computer of a user, a first hash value corresponding to a first string input into a password field of an application provided by a service provider;
determining, based on accessing a database using the first hash value, data characteristics corresponding to the first hash value, the data characteristics indicating use of the first string as a password value by one or more other users;
determining, based on the data characteristics, a password strength corresponding to the first hash value; and
causing the user computer to display an indication of the password strength

16. The non-transitory computer readable medium of claim 15, wherein the operations further comprise:
receiving, from the user computer, a second hash value corresponding to a second string input into the password field, wherein the second string comprises a subsequent string concantentated to an end of the first string;
causing the user computer to display an updated indication of the password strength based on the second has value.

17. The non-transitory computer readable medium of claim 16, wherein the database stores mappings between a plurality of hash values and respective data characteristics that indicate use of the strings represented by the hash values as password values by a plurality of users.

18. The non-transitory computer readable medium of claim 17, wherein the plurality of hash values include the first hash value and the plurality of users includes the one or more other users.

19. The non-transitory computer readable medium of claim 15, wherein the data characteristics include frequency information indicating a number of instances in which the first string represented by the first hash value has been input as a potential password for one or more applications.

20. The non-transitory computer readable medium of claim 15, wherein the operations further comprise:
determining whether the first hash value fails to satisfy one or more password rules based on one or more properties of the first hash value.
